(19) United States
(12) Patent Application Publication
(10) Pub. No.: US 2023/0068512 A1
(43) Pub. Date: Mar. 2, 2023

(54) FRACTAL OPTIMIZED CORE SHAPE (ADDMFG)

(71) Applicant: Hamilton Sundstrand Corporation, Charlotte, NC (US)

(72) Inventors: John Giuliano, North Granby, CT (US); Paul M. Colson, Westfield, MA (US)

(21) Appl. No.: 17/881,169

(22) Filed: Aug. 4, 2022

Related U.S. Application Data
(60) Provisional application No. 63/239,270, filed on Aug. 31, 2021.

(51) Int. Cl. F28D 1/047; F28F 9/00; F28F 1/00

(52) U.S. Cl. CPC F28D 1/0475; F28F 9/00; F28F 1/006

(57) ABSTRACT

A heat exchanger includes a heat exchanger core. The heat exchanger core includes a plurality of tubes. Each tube of the plurality of tubes includes a first end and a second end and extends from the first end to the second end in a lengthwise direction. Each tube of the plurality of tubes is spaced from adjacent tubes in a height-wise direction and a widthwise direction. The plurality of tubes is stacked to create a concave profile in the height-wise direction and widthwise direction. The concave profile extends in the lengthwise direction.

### CROSS-REFERENCE TO RELATED APPLICATION

This application claims the benefit of the U.S. Provisional Application No. 63/239,270, filed Aug. 31, 2021, for “FRACTAL OPTIMIZED CORE SHAPE (ADDMFG),” which is fully incorporated by reference herein.

### BACKGROUND

The present disclosure relates to heat exchangers, and more particularly, to a heat exchanger cores.

Heat exchangers are often used to transfer heat between two fluids. For example, in aircraft environmental control systems, heat exchangers may be used to transfer heat between a relatively hot air source (e.g., bleed air from a gas turbine engine) and a relatively cool air source (e.g., ram air).

### SUMMARY

In one example, a heat exchanger includes a heat exchanger core. The heat exchanger core includes a plurality of tubes. Each tube of the plurality of tubes includes a first end and a second end and extends from the first end to the second end in a lengthwise direction. Each tube of the plurality of tubes is spaced from adjacent tubes in a height-wise direction and a widthwise direction. The plurality of tubes is stacked to create a concave profile in the height-wise direction and widthwise direction. The concave profile extends in the lengthwise direction.

In another example, a heat exchanger includes a first header, a second header, and a core. The first header includes an inlet and an outlet. The outlet is fluidically connected to the inlet. The second header includes an inlet and an outlet. The outlet of the second header is fluidically connected to the inlet of the second header. The core includes a plurality of tubes and each tube of the plurality of tubes extends in a lengthwise direction from a first end to a second end. The first end of each tube of the plurality of tubes is fluidically connected to the outlet of the first header, and the second end of each tube of the plurality of tubes is fluidically connected to the inlet of the second header. The plurality of tubes is stacked to create a concave profile in the height-wise direction and the widthwise direction, and the concave profile extends in the lengthwise direction.

Persons of ordinary skill in the art will recognize that other aspects and embodiments of the present invention are possible in view of the entirety of the present disclosure, including the accompanying figures.

### BRIEF DESCRIPTION OF THE DRAWINGS

FIG. 1 is a perspective view of a heat exchanger.

FIG. 2A is a schematic of a cross-sectional view of the heat exchanger from FIG. 1 taken at line A-A.

FIG. 2B is a schematic of a cross-sectional view of heat exchanger from FIG. 1 taken at line A-A.

FIG. 3 is a perspective view of an alternative embodiment of a heat exchanger.

FIG. 4 is a perspective view of an alternative embodiment of a core of a heat exchanger.

While the above-identified drawing figures set forth one or more embodiments of the invention, other embodiments are also contemplated. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings. Like reference numerals identify similar structural elements.

### DETAILED DESCRIPTION

This disclosure relates to an additively manufactured heat exchanger with plenum headers or with fractal headers that utilizes a non-rectangular core as a means of capturing and retaining the external flow. The heat exchanger includes a first header, a second header (hereinafter first header and second header can be referred to together as “headers”), and a core. The first header includes an inlet and an outlet. The second header includes an inlet and an outlet. The core includes a plurality of tubes that extends from a first end to a second end in a lengthwise direction. Each tube of the plurality of tubes is spaced from adjacent tubes in a height-wise direction and a widthwise direction. The plurality of tubes is stacked to create a concave profile in the height-wise direction and the widthwise direction. The concave profile extends in the lengthwise direction. In one example, each tube of the plurality of tubes can also include a bend between the first end and the second end. The first end of each tube of the plurality of tubes is fluidically connected to the outlet of the first header. The second end of each tube of the plurality of tubes is fluidically connected to the inlet of the second header.

As discussed above, the heat exchanger can include non-fractal headers. In another example, the heat exchanger can include fractal headers. Fractal headers include an inlet, a primary flow duct, a plurality of secondary flow ducts, and a multiplicity of tertiary flow ducts. The primary flow duct is fluidically connected to the inlet of the header. The plurality of secondary flow ducts is fluidically connected to the inlet by the primary flow duct. The primary flow duct splits to form the plurality of secondary flow ducts. The multiplicity of tertiary flow ducts is fluidically connected to the inlet by the plurality of secondary flow ducts and the primary flow ducts. Each of the plurality of secondary flow ducts splits to form the multiplicity of tertiary flow ducts. When the heat exchanger includes fractal headers, the first end of each tube of the plurality of tubes is connected to one flow duct of the multiplicity of tertiary flow ducts of the first header. The second end of each tube of the plurality of tubes is connected to one flow duct of the multiplicity of tertiary flow ducts of the second header.

The heat exchangers as discussed above can be surrounded by a flow housing that includes an inlet and an outlet. The inlet of the flow housing is fluidically connected to the outlet of the flow housing. The first header, the core, and the second header form a primary flow path and the flow housing forms a secondary flow path. At least the plurality of tubes are disposes inside the flow housing. The primary flow path is fluidically isolated from the secondary flow path. The concave profile of the plurality of tubes faces an upstream direction of the secondary path. In another example, the plurality of tubes can be stacked to include a second concave profile. Together the first concave profile and the second concave profile form a sinusoidal profile. The sinusoidal profile can extend the entire length of the plurality of tubes in the lengthwise direction. Similar to the concave profile, the sinusoidal profile faces the upstream direction of the secondary flow path. Both the concave profile and the sinusoidal profile help direct a secondary flow as the secondary flow traverses the plurality of tubes. The concave profiles and the sinusoidal profile help distribute the secondary flow across the plurality of tubes to improve the heat transfer capabilities of the heat exchanger. In another example, the plurality of tubes can include a bend that increases the surface area of the plurality of tubes, which increases the heat transfer capabilities of the heat exchanger. The bend in the plurality of tubes also helps customize the shape of the heat exchanger so that the heat exchanger can fit in tight and/or customized envelopes.

Heat exchangers often utilize a rectangular core with shrouding or ducting to direct the external flow over the heat exchanger surface. In high-performance heat exchangers, this shrouding can face several challenges: the shrouding adds weight to the heat exchanger system, the shrouding can be susceptible to failure due to vibrational forces and, the shrouding can capture heat that generates thermal stresses and result in thermal expansion of the heat exchanger. The heat exchanger as discussed above addresses these concerns by changing the shape of the heat exchanger core and reducing the effects of external flow loss without using shrouds. The heat exchanger will be discussed below with reference to the figures.

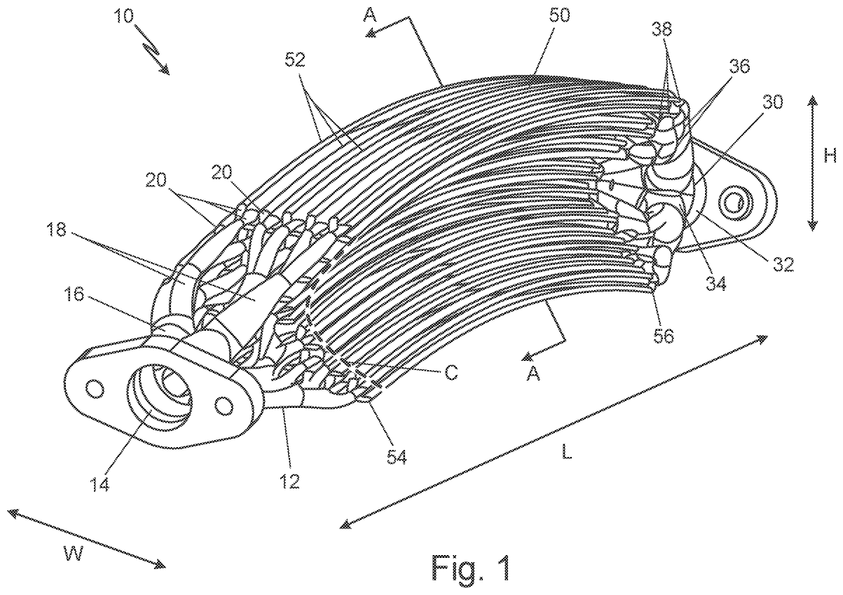

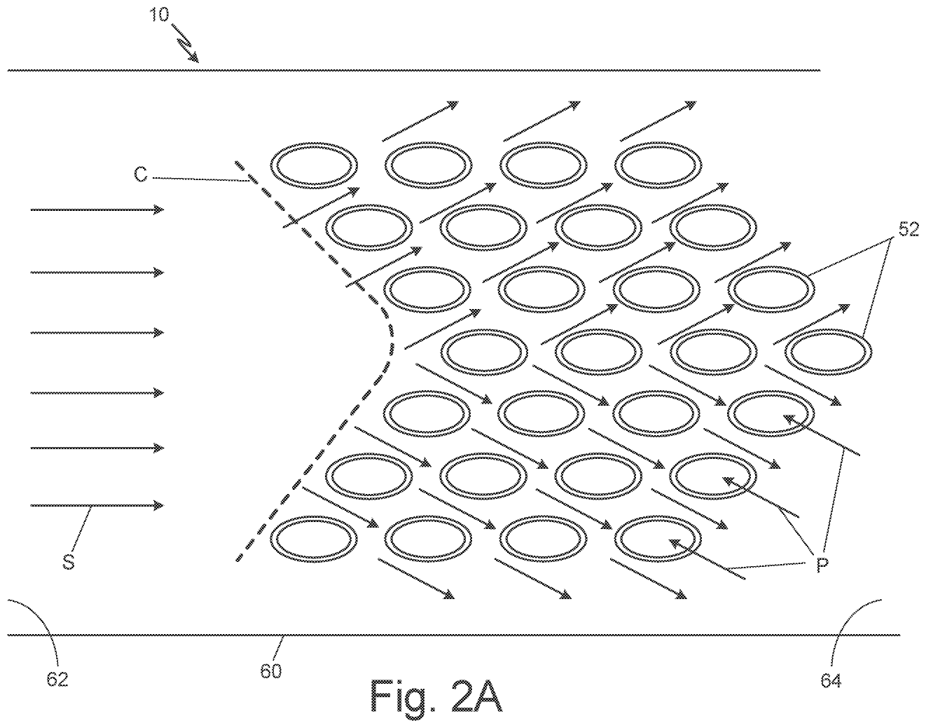

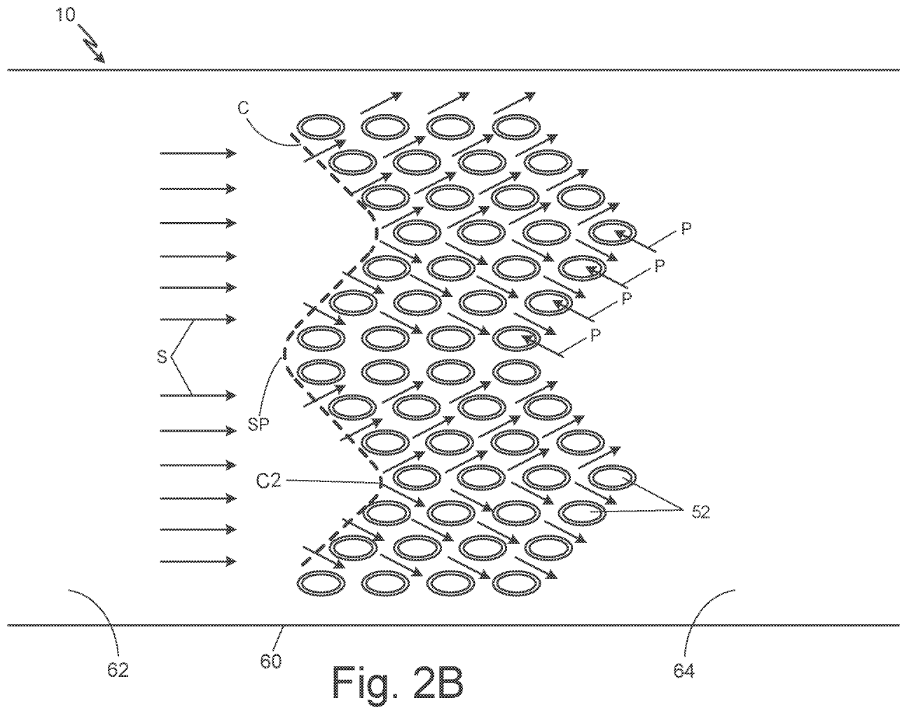

FIG. 1 is a perspective view of heat exchanger 10. Heat exchanger 10 includes first header 12, second header 30, and core 50. As shown in FIG. 1, first header 12 includes first header inlet 14, primary flow duct 16, plurality of secondary flow ducts 18 (referred to as “secondary flow ducts 18”), and multiplicity of tertiary flow ducts 20 (referred to as tertiary flow ducts 20″). As also shown in FIG. 1, second header 30 includes second header outlet 32, primary flow duct 34, plurality of secondary flow ducts 36 (referred to as “secondary flow ducts 36”), and multiplicity of tertiary flow ducts 38 (referred to as tertiary flow ducts 38″). Core 50 includes plurality of tubes 52 (referred to as “tubes 52”). Each tube of tubes 52 includes first end 54 and second end 56. Flow housing 60, as shown in FIG. 2, includes flow housing inlet 62 and flow housing outlet 64. Heat exchanger 10 also includes lengthwise direction L, widthwise direction W, and height-wise direction H. Tubes 52 form concave profile C.

As shown in FIG. 1, first header 12 is a header with fractal geometry. Primary flow duct 16 of first header 12 is fluidically connected to first header inlet 14. Primary flow duct 16 of first header 12 splits to form secondary flow ducts 18 of first header 12. Secondary flow ducts 18 of first header 12 are fluidically connected to first header inlet 14 by primary flow duct 16 of first header 12. Each flow duct of secondary flow ducts 18 of first header 12 splits to form tertiary flow ducts 20 of first header 12. Tertiary flow ducts 20 are fluidically connected to first header inlet 14 by secondary flow ducts 18 of first header 12 and primary flow duct 16 of first header 12.

As also shown in FIG. 1, second header 30 is a header with fractal geometry. Primary flow duct 34 of second header 30 is fluidically connected to second header outlet 32. Primary flow duct 34 of second header 30 splits to form secondary flow ducts 36 of second header 30. Secondary flow ducts 36 of second header 30 are fluidically connected to second header outlet 32 by primary flow duct 34 of second header 30. Each flow duct of secondary flow ducts 36 of second header 30 splits to form tertiary flow ducts 38 of second header 30. Tertiary flow ducts 38 are fluidically connected to second header outlet 32 by secondary flow ducts 36 of second header 30 and primary flow duct 34 of second header 30.

Each tube of tubes 52 extends from first end 54 to second end 56 in lengthwise direction L. Each tube of tubes 52 is spaced from adjacent tubes in height-wise direction H and widthwise direction W. Tubes 52 are stacked to create concave profile C in height-wise direction H and widthwise direction W. Concave profile C extends in lengthwise direction L. In the example shown in FIG. 1, concave profile C extends the entire length of tubes 52 in lengthwise direction L. In another example, concave profile C can extend a portion of the length of tubes 52 in lengthwise direction L. First end 54 of each tube of tubes 52 is connected to one of tertiary flow ducts 20 of first header 12. Second end 56 of each tube of tubes 52 is connected to one of tertiary flow ducts 38 of second header 30.

FIG. 2A is a schematic of a cross-sectional view of heat exchanger 10 taken at line A-A. Heat exchanger 10 includes flow housing 60. Flow housing 60 includes flow housing inlet 62 and housing outlet 64. Flow housing 60 can be a duct, an envelope, shroud, or a manifold. As shown in FIG. 2A, primary flow path P flows through tubes 52 either into or out of the page. In the example shown in FIG. 2A, flow housing 60 surrounds first header 12, second header 30, and core 50. In another example, flow housing 60 can surround just core 50. Flow housing inlet 62 is fluidically connected to flow housing outlet 64. First header 12, second header 30, and core 50 form primary flow path P. Flow housing 60 forms secondary flow path S with secondary flow path S passing through the spaces between tubes 52. Primary fluid path P is fluidically isolated from secondary fluid path S.

In one example, secondary flow path S flows transverse to primary flow path P and between tubes 52. In another example, secondary flow path S flows parallel to primary flow path P and between tubes 52. In yet another example, tubes 52 are curved such that secondary flow path S flows transverse to primary flow path P at some portion of tubes 52, and secondary flow path S flows parallel to primary flow path P at some portion of tubes 52. Concave profile C faces an upstream direction of secondary flow path S. Because concave profile C faces the upstream direction of secondary flow path S, concave profile C has a greater surface area in contact with secondary flow path S as secondary flow path S enters between tubes 52. The increased surface area in contact between concave profile C and secondary flow path S helps mitigate losses as secondary flow path S flows between tubes 52. Because there are reduced losses as secondary flow path S travels through tubes 52, secondary flow path S is better distributed across tubes 52. Thus, as a result of concave profile C, secondary flow path S contacts more surface area of tubes 52. The increase of contact between secondary flow path S and tubes 52 results in greater heat transfer of a fluid in primary flow path P and a fluid in secondary flow path S. In one example, the fluid in primary flow path P can be a hot fluid, (e.g., bleed air from a gas turbine engine) and the fluid in secondary flow path S can be a cold fluid (e.g., ram air). In another example, the fluid in primary flow path P can be a cold fluid (e.g., ram air) and the fluid in secondary flow path S can be a hot fluid, (e.g., bleed air from a gas turbine engine).

In the example of FIG. 2A, tubes 52 are stacked to form concave profile C. In another example, as shown in FIG. 2B, tubes 52 can be stacked to create second concave profile C2 in height-wise direction H and widthwise direction W. Together second concave profile C2 extends in the lengthwise direction. Concave profile C and second concave profile C2 form sinusoidal profile SP. Sinusoidal profile SP extends an entire length of tubes 52 in lengthwise direction L. Sinusoidal profile SP faces an upstream direction of secondary flow path S. Because sinusoidal profile SP faces the upstream direction of secondary flow path S, sinusoidal profile SP has a greater surface area in contact with secondary flow path S as secondary flow path S enters between tubes 52. The increased surface area in contact between sinusoidal profile SP and secondary flow path S helps mitigate losses as secondary flow path S navigates between tubes 52. Because there are reduced losses as secondary flow path S travels through tubes 52, secondary flow path S is better distributed across tubes 52. Thus, as a result of sinusoidal profile SP, secondary flow path S contacts more surface area of tubes 52. The increase of contact between secondary flow path S and tubes 52 results in greater heat transfer of a fluid in primary flow path P and a fluid in secondary flow path S. In yet another example, tubes 52 can be stacked to create a U-shaped, V-shaped, repeating wave, parabolic, square wave, convex, hemispherical, dished, semi-elliptical, torispherical, toriconical, conical, semi-cylindrical, and/or any other profile shape that can help guide secondary flow S through tubes 52.

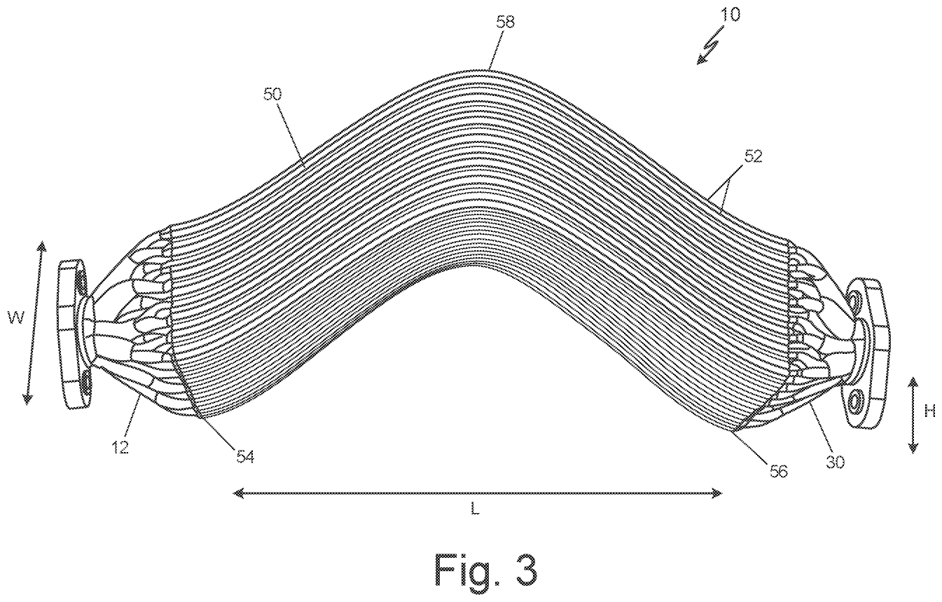

FIG. 3 is a perspective view of an alternative embodiment of heat exchanger 10. As shown in FIG. 3, each tube of tubes 52 can include bend 58 between first end 54 and second end 56. Bend 58 in tubes 52 between first end 54 and second end 56 allows core 50 to have an increased length and be packed in the same linear distance in longitudinal direction L. As a result of core 50 having an increased length, heat exchanger 10 has an increased surface area of tubes 52. The increased surface area of tubes 52 increases the heat transfer capabilities of heat exchanger 10. Further, bend 58 can be altered to fit heat exchanger 10 within a tight or custom envelop, while maintaining heat exchanger capabilities as compared to traditional heat exchangers, which are generally box-shaped.

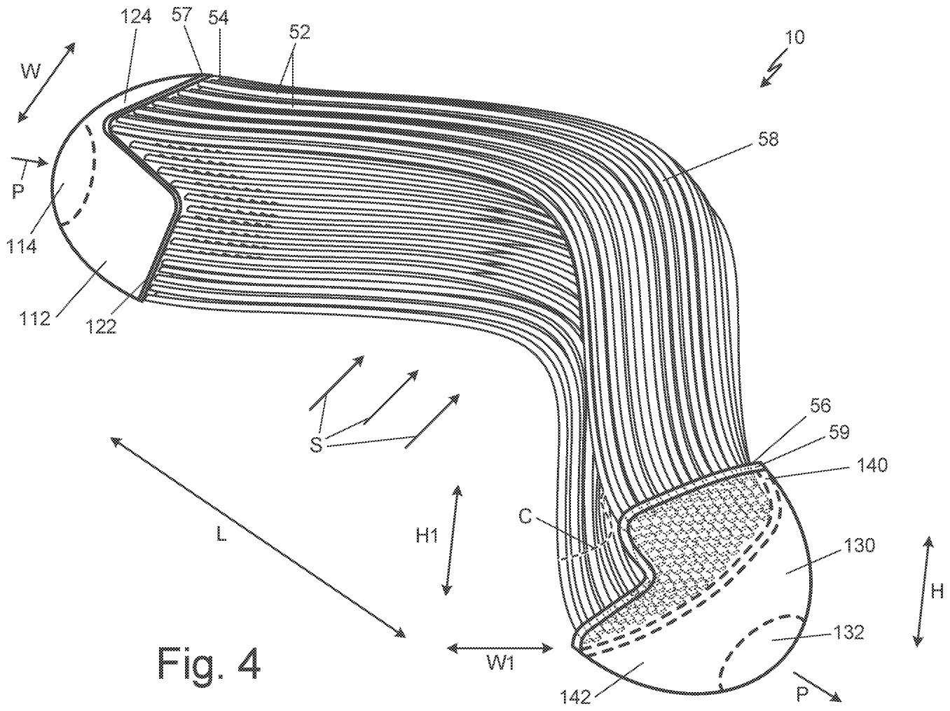

FIG. 4 is a perspective view of an alternative embodiment of core 50 of heat exchanger 10. As shown in FIG. 4, core 50 includes first panel 57 and second panel 59. First panel 57 extends in height-wise direction H1 and extends widthwise direction W1. Second 59 extends in height-wise direction H2 and extends in widthwise direction W2. First end 54 of each tube of tubes 52 extends through first panel 57. Second end 56 of each tube of tubes 52 extends through second panel 59. First panel 57 and second panel 59 help support core 50 and improve the durability of heat exchanger 10. Additionally, first panel 57 and second panel 59 support core 50 so that core 50 can be additively manufactured without first header 112 or second header 130.

As shown in FIG. 4, heat exchanger 10 first header 112 and second header 130 can be plenum headers. First header 114 includes first header inlet 114, first header outlet 122, and first header plenum 124, which fluidically connects first header inlet 114 to first header outlet 122. Second header 130 includes second header outlet 132, second header inlet 140, and second header plenum 142, which fluidically connects second header outlet 132 and second header inlet 140. First header 112 can be welded or brazed to first panel 57 and second header 130 can be welded or brazed to second panel 59.

As shown in FIG. 4, each tube of tubes 52 is stacked in concave profile C in height-wise direction H and widthwise direction W. Concave profile C of tubes 52 extends in lengthwise direction L. As discussed above, tubes 52 with concave profile C have a greater surface area between secondary flow path S and tubes 52 than traditional heat exchangers, which are typically box-shaped. The increase of surface area between secondary flow path S and tubes 52 results in greater heat transfer capabilities. In addition to concave profile C, in the example of FIG. 4, tubes 52 of core 50 includes bend 58 between first end 54 and second end 56. As discussed above, bend 58 also increases the heat transfer of heat exchanger 10. Therefore, as shown in FIG. 4, heat exchanger 10 has the benefit of having tubes 52 with concave profile C and tubes 52 having bend 58 between first end 54 and second end 56 of tubes 52. Thus, heat exchanger 10 as shown in FIG. 4 has improved heat transfer capabilities over traditional heat exchangers.

To obtain these complex geometries, heat exchanger 10 can be made using additive manufacturing. In one example, first header 12, second header 30, and core 50 can be additively manufactured a single monolithic part in a single additive manufacturing process. In another example, first header 12 and core 50 can be additively manufactured as a single monolithic part in a single additive manufacturing process. When first header 12 and core 50 are a single monolithic part second header 30 can be brazed or welded to first header 12 and core 50. In another example, second header 30 and core 50 can be additively manufactured in as a single monolithic part in a single additive manufacturing process. When second header 30 and core 50 are a single monolithic part first header 12 can be brazed or welded to second header 30 and core 50. In yet another example, first header 12 and second header 30 can be additively manufactured, core 50 can be additively manufactured in a second process, and first header 12 and second header 30 can be brazed or welded to core 50. Another benefit of the bend in tubes 52 is that the bend in tubes 52 allows a heat exchanger of greater heat exchange properties (longer surface area of tubes 52) to be built on an additively manufacturing machine with a smaller build platform.

### Discussion of Possible Embodiments

The following are non-exclusive descriptions of possible embodiments of the present invention.

A heat exchanger includes a heat exchanger core. The heat exchanger core includes a plurality of tubes. Each tube of the plurality of tubes includes a first end and a second end and extends from the first end to the second end in a lengthwise direction. Each tube of the plurality of tubes is spaced from adjacent tubes in a height-wise direction and a widthwise direction. The plurality of tubes is stacked to create a concave profile in the height-wise direction and widthwise direction. The concave profile extends in the lengthwise direction.

The heat exchanger of the preceding paragraph can optionally include, additionally and/or alternatively, any one or more of the following features, configurations and/or additional components:

wherein the concave profile extends an entire length of the plurality of tubes in the lengthwise direction;

wherein each tube of the plurality of tubes includes a bend between the first end and the second end;

further including: a first header including: an inlet; a primary flow duct fluidically connected to the inlet; a plurality of secondary flow ducts fluidically connected to the inlet by the primary flow duct, wherein the primary flow duct splits to form the plurality of secondary flow ducts; and a multiplicity of tertiary flow ducts fluidically connected to the inlet by the plurality of secondary flow ducts and the primary flow duct, wherein each flow duct of the plurality of secondary flow ducts splits to form the multiplicity of tertiary flow ducts; and a second header including: an outlet; a primary flow duct fluidically connected to the outlet; a plurality secondary flow ducts fluidically connected to the outlet by the primary flow duct of the second header, wherein the primary flow duct of the second header splits to form the plurality of secondary flow ducts of the second header; and a multiplicity of tertiary flow ducts fluidically connected to the outlet by the plurality of secondary flow ducts of the second header and the primary flow duct of the second header, wherein each flow duct of the plurality of secondary flow ducts of the second header splits to form the multiplicity of tertiary flow ducts of the second header;

wherein the first end of each tube of the plurality of tubes is connected to one of the multiplicity of tertiary flow ducts of the first header, and wherein the second end of each tube of the plurality of tubes is connected to one of the multiplicity of tertiary flow ducts of the second header;

including a flow housing that surrounds the heat exchanger core, wherein the flow housing includes an inlet and an outlet, and wherein the inlet of the flow housing and the outlet of the flow housing are fluidically connected;

wherein the flow housing is a duct, an envelope, a shroud, or a manifold, and wherein the first header, the heat exchanger core, and the second header form a primary flow path, and wherein the flow housing forms a secondary flow path;

wherein the primary flow path is fluidically isolated from the secondary flow path, and wherein the secondary flow path is transverse to the primary flow path; and/or

wherein the concave profile faces an upstream direction of the secondary flow path.

In another example, a heat exchanger includes a first header, a second header, and a core. The first header includes an inlet and an outlet. The outlet is fluidically connected to the inlet. The second header includes an inlet and an outlet. The outlet of the second header is fluidically connected to the inlet of the second header. The core includes a plurality of tubes and each tube of the plurality of tubes extends in a lengthwise direction from a first end to a second end. The first end of each tube of the plurality of tubes is fluidically connected to the outlet of the first header, and the second end of each tube of the plurality of tubes is fluidically connected to the inlet of the second header. The plurality of tubes is stacked to create a concave profile in the height-wise direction and the widthwise direction, and the concave profile extends in the lengthwise direction.

The heat exchanger of the preceding paragraph can optionally include, additionally and/or alternatively, any one or more of the following features, configurations and/or additional components:

wherein the concave profile extends an entire length of the plurality of tubes in the lengthwise direction;

wherein the core further includes: a first panel extending in a height-wise direction and extending in a widthwise direction; and a second panel extending in a height-wise direction and extending in a widthwise direction, wherein the first end of each plurality of tubes extends through the first panel, and the second end of each plurality of tubes extends through the second panel, and wherein each tube of the plurality of tubes includes a bend between the first end and the second end;

wherein the plurality of tubes are stacked to create a second concave profile in the height-wise direction and the widthwise direction, wherein the second concave profile extends in the lengthwise direction;

wherein the concave profile and the second concave profile together form a sinusoidal profile extending an entire length of the plurality of tubes in the lengthwise direction;

wherein the heat exchanger further includes: a flow housing that surrounds the core, wherein the flow housing includes: an inlet fluidically connected to an outlet;

wherein the first header, the core, and the second header form a primary flow path, and wherein flow housing forms a secondary flow path;

wherein the primary flow path is fluidically isolated from the secondary flow path, wherein the secondary flow path is transverse to the primary flow path, and wherein the sinusoidal profile faces an upstream direction of the secondary flow path;

wherein the core is additively manufactured, and wherein the first header and the second header are brazed or welded to the core;

wherein the first header and the core are additively manufactured as a single monolithic part; and/or

wherein the first header, the core, and the second header are additively manufactured as a single monolithic part.

While the invention has been described with reference to an exemplary embodiment(s), it will be understood by those skilled in the art that various changes may be made and equivalents may be substituted for elements thereof without departing from the scope of the invention. For example, tubes 52 can be made from shapes with irregular cross-sections to further improve the surface area between primary flow path P and secondary flow path S, which will increase the heat transfer between fluids flowing through primary flow path P and fluids flowing through secondary flow path S. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A heat exchanger comprising:
a heat exchanger core, wherein the heat exchanger core comprises:
a plurality of tubes comprising:
a first end; and
a second end, wherein each tube of the plurality of tubes extends from the first end to the second end in a lengthwise direction, and wherein each tube of the plurality of tubes is spaced from adjacent tubes in a height-wise direction and a widthwise direction,
wherein the plurality of tubes is stacked to create a concave profile in the height-wise direction and widthwise direction, and wherein the concave profile extends in the lengthwise direction.

2. The heat exchanger of claim 1, wherein the concave profile extends an entire length of the plurality of tubes in the lengthwise direction.

3. The heat exchanger of claim 2, wherein each tube of the plurality of tubes comprises a bend between the first end and the second end.

4. The heat exchanger of claim 3, further comprising:
a first header comprising:
an inlet;
a primary flow duct fluidically connected to the inlet;
a plurality of secondary flow ducts fluidically connected to the inlet by the primary flow duct, wherein the primary flow duct splits to form the plurality of secondary flow ducts; and
a multiplicity of tertiary flow ducts fluidically connected to the inlet by the plurality of secondary flow ducts and the primary flow duct, wherein each flow duct of the plurality of secondary flow ducts splits to form the multiplicity of tertiary flow ducts; and
a second header comprising:
an outlet;
a primary flow duct fluidically connected to the outlet;
a plurality secondary flow ducts fluidically connected to the outlet by the primary flow duct of the second header, wherein the primary flow duct of the second header splits to form the plurality of secondary flow ducts of the second header; and
a multiplicity of tertiary flow ducts fluidically connected to the outlet by the plurality of secondary flow ducts of the second header and the primary flow duct of the second header, wherein each flow duct of the plurality of secondary flow ducts of the second header splits to form the multiplicity of tertiary flow ducts of the second header.

5. The heat exchanger of claim 4, wherein the first end of each tube of the plurality of tubes is connected to one of the multiplicity of tertiary flow ducts of the first header, and wherein the second end of each tube of the plurality of tubes is connected to one of the multiplicity of tertiary flow ducts of the second header.

6. The heat exchanger of claim 5 comprising a flow housing that surrounds the heat exchanger core, wherein the flow housing comprises an inlet and an outlet, and wherein the inlet of the flow housing and the outlet of the flow housing are fluidically connected.

7. The heat exchanger of claim 6, wherein the flow housing is a duct, an envelope, a shroud, or a manifold, and wherein the first header, the heat exchanger core, and the second header form a primary flow path, and wherein the flow housing forms a secondary flow path.

8. The heat exchanger of claim 7, wherein the primary flow path is fluidically isolated from the secondary flow path, and wherein the secondary flow path is transverse to the primary flow path.

9. The heat exchanger of claim 8, wherein the concave profile faces an upstream direction of the secondary flow path.

10. A heat exchanger comprising:
a first header comprising:
an inlet; and
an outlet, wherein the outlet is fluidically connected to the inlet;
a second header comprising:
an inlet; and
an outlet, wherein the outlet of the second header is fluidically connected to the inlet of the second header; and
a core comprising:
a plurality of tubes, wherein each tube of the plurality of tubes extends in a lengthwise direction from a first end to a second end, wherein the first end of each tube of the plurality of tubes is fluidically connected to the outlet of the first header, and the second end of each tube of the plurality of tubes is fluidically connected to the inlet of the second header, wherein the plurality of tubes are stacked to create a concave profile in a height-wise direction and a widthwise direction, and wherein the concave profile extends in the lengthwise direction.

11. The heat exchanger of claim 10, wherein the concave profile extends an entire length of the plurality of tubes in the lengthwise direction.

12. The heat exchanger of claim 11, wherein the core further comprises:
a first panel extending in a height-wise direction and extending in a widthwise direction; and
a second panel extending in a height-wise direction and extending in a widthwise direction,
wherein the first end of each plurality of tubes extends through the first panel, and the second end of each plurality of tubes extends through the second panel, and wherein each tube of the plurality of tubes comprises a bend between the first end and the second end.

13. The heat exchanger of claim 10, wherein the plurality of tubes are stacked to create a second concave profile in the height-wise direction and the widthwise direction, wherein the second concave profile extends in the lengthwise direction.

14. The heat exchanger of claim 13, wherein the concave profile and the second concave profile together form a sinusoidal profile extending an entire length of the plurality of tubes in the lengthwise direction.

15. The heat exchanger of claim 14, wherein the heat exchanger further comprises:
a flow housing that surrounds the core, wherein the flow housing comprises:
an inlet fluidically connected to an outlet.

16. The heat exchanger of claim 15, wherein the first header, the core, and the second header form a primary flow path, and wherein flow housing forms a secondary flow path.

17. The heat exchanger of claim 16, wherein the primary flow path is fluidically isolated from the secondary flow path, wherein the secondary flow path is transverse to the primary flow path, and wherein the sinusoidal profile faces an upstream direction of the secondary flow path.

18. The heat exchanger of claim 16, wherein the core is additively manufactured, and wherein the first header and the second header are brazed or welded to the core.

19. The heat exchanger of claim 16, wherein the first header and the core are additively manufactured as a single monolithic part.

20. The heat exchanger of claim 16, wherein the first header, the core, and the second header are additively manufactured as a single monolithic part.
